(19) United States
(12) Patent Application Publication
(10) Pub. No.: US 2026/0109647 A1
(43) Pub. Date: Apr. 23, 2026

(54) EPOXY-GEOPOLYMER HYBRID FOAM

(71) Applicant: Carboline International Corporation, St. Louis, MO (US)

(72) Inventors: Thomas Hope, St. Louis, MO (US); Steven Bockhold, St. Louis, MO (US); Jared Dachroeden, St. Louis, MO (US); Edward Taylor, Ballwin, MO (US)

(73) Assignee: Carboline International Corporation, St. Louis, MO (US)

(21) Appl. No.: 19/115,740

(22) PCT Filed: Dec. 1, 2022
(86) PCT No.: PCT/US2022/051525

§ 371 Date: Mar. 26, 2025

Related U.S. Application Data
(60) Provisional application No. 63/410,512, filed on Sep. 27, 2022.

(51) Int. Cl. C04B 28/00; C04B 40/06; C08G 59/40; C08J 9/10

(52) U.S. Cl. CPC C04B 28/006; C04B 40/065; C08G 59/4071; C08J 9/105; C08J 2363/00

(57) ABSTRACT

A multi-part composition comprises a curable part and a curing part. The curable part comprises a curable epoxy resin and a first silicate component. The curing part comprises a curing agent and a second silicate component. The curable part or the curing part include a chemical blowing agent. The first silicate component and the second silicate component are different. The multi-part composition further comprises water. When mixed and cured, the multi-part composition forms an epoxy-geopolymer hybrid foam.

### CROSS-REFERENCE TO RELATED APPLICATIONS

This application claims priority to and the benefit of U.S. Provisional Patent Application No. 63/410,512, filed Sep. 27, 2022, the entire content of which is incorporated by reference herein.

### FIELD

This disclosure relates to a composition for forming an epoxy-geopolymer hybrid foam, and methods for forming an epoxy-geopolymer hybrid foam.

### BACKGROUND

Polymer foams are used in building and construction applications as filler materials, insulation, and protective materials. Many polymer foams are formed from two-part compositions comprising a curable resin and a curing agent. A chemical blowing agent or physical blowing can be used to assist in foaming. For some applications, for example those using chemical blowing agents, heat is required for foaming. It is known that foaming may occur slowly, or may not occur at all, at lower temperatures such as room temperature. Others using chemical blowing agents may require a solvent. However, foams produced with solvents will result in undesirable off-gassing as a result of the foaming reaction and/or residual solvent escaping from the produced foam.

### SUMMARY

The present disclosure provides a multi-part composition comprising at least a curable part and a curing part. The curable part comprises a curable epoxy resin and an alumino silicate component. The curing part comprises a curing agent and an alkali silicate or alkaline earth silicate component. The multi-part composition also comprises a chemical blowing agent, which may be present in the curable part or separate from the curable part, e.g., in a foaming part of the multi-part composition. The multi-part composition comprises 0.1 to 80 weight % of water. When mixed and cured, the multi-part composition forms an epoxy-geopolymer hybrid foam.

In addition, a method for preparing an epoxy-geopolymer hybrid foam is described in the present disclosure. The method comprises a step of mixing the multi-part composition disclosed herein. An epoxy-geopolymer hybrid foam is formed in which the geopolymer is dispersed within the epoxy polymer foam matrix.

### BRIEF DESCRIPTION OF DRAWINGS

FIG. 1A is a photograph of a multi-part composition according to the present disclosure immediately after the multi-part composition is mixed.

FIG. 1B is a photograph of the multi-part composition of FIG. 1A about 1 hour after the multi-part composition is mixed.

FIG. 1C is a photograph of the multi-part composition of FIG. 1A about 1 hour and 25 minutes after the multi-part composition is mixed.

FIG. 2A is a graph illustrating the compressive strength of an epoxy-geopolymer hybrid foam according to the present disclosure and existing insulative foam products.

FIG. 2B is a graph illustrating the results of a cryogenic exposure test of an epoxy-geopolymer hybrid foam according to the present disclosure and existing insulative foam products.

FIG. 3A is ²⁷Al NMR spectrum of samples of unreacted geopolymer ingredients, cured geopolymer, cured geopolymer pulverized than mixed with an epoxy foam, and an epoxy-geopolymer hybrid foam prepared in accordance with the present disclosure.

FIG. 3B is ²⁹Si NMR spectrum of samples of unreacted geopolymer ingredients, cured geopolymer, cured geopolymer pulverized than mixed with an epoxy foam, and an epoxy-geopolymer hybrid foam prepared in accordance with the present disclosure.

FIG. 4 is infrared spectrum of cured epoxy resin, alumino silicate, cured geopolymer, and an epoxy-geopolymer hybrid foam prepared in accordance with the present disclosure.

FIG. 5A is GC-MS chromatogram of the gas collected from the foaming reaction of p,p′-oxybis(benzenesulfonyl-hydrazide) and an amine activator.

FIG. 5B is the analysis result of the GC-MS chromatogram of FIG. 5A.

FIG. 6A is a graph illustrating the rate of N₂ gas production by Anquamine 401 and p,p′-oxybis(benzenesulfonyl-hydrazide) under different conditions.

FIG. 6B is a graph illustrating the rate of N₂ gas production by tetraethylenepentamine and p,p′-oxybis(benzenesulfonyl-hydrazide) under different conditions.

FIG. 6C is a graph illustrating the rate of N₂ gas production by p,p′-oxybis(benzenesulfonyl-hydrazide) with various chemicals.

FIG. 7 is a graph illustrating the differential scanning calorimetry curves of an epoxy-geopolymer hybrid foam prepared in accordance with the present disclosure, an epoxy foam formed without geopolymer, the epoxy foam with inert filler, and a PU adhesive foam product.

FIG. 8 is a graph illustrating time-temperature furnace curves of specimens coated with an epoxy-geopolymer hybrid foam prepared in accordance with the present disclosure, an epoxy foam formed without geopolymer, the epoxy foam with inert filler, and a fire-stopping foam product.

FIG. 9 is a photograph of an epoxy-geopolymer hybrid foam prepared in accordance with the present disclosure, and other insulation foams, after direct exposure to concentrated sulfuric acid.

### DETAILED DESCRIPTION

A multi-part composition for forming an epoxy-geopolymer hybrid foam is described in the present disclosure. The multi-part composition comprises at least a curable part and a curing part. The curable part comprises a curable epoxy resin and an alumino silicate component. The curing part comprises a curing agent and an alkali silicate or alkaline earth silicate component. The multi-part composition further comprises a chemical blowing agent, which may be present in the curable part or separate from the curable part, e.g., in a foaming part of the multi-part composition. The multi-part composition comprises an activator that activates the chemical blowing agent, where the curing agent may also act as the activator. In other words, the curing agent may be the activator, or a component other than the curing agent may be present as the activator.

The multi-part composition further comprises water, and may optionally comprise a base component and/or additives.

In addition, a method for preparing an epoxy-geopolymer hybrid foam is described in the present disclosure. The method comprises a step of mixing the multi-part composition disclosed herein. An epoxy-geopolymer hybrid foam is formed in which the geopolymer is dispersed within the epoxy polymer foam matrix.

### Curable Part

As discussed above, the multi-part composition comprises a curable part. The curable part comprises a curable epoxy resin. Suitable curable epoxy resins that may be used include, but are not limited to, polyglycidyl ether of a polyhydric phenol such as polyglycidyl ethers of bisphenol A and polyglycidyl ethers of bisphenol F; polyglycidyl amines; polyglycidyl ethers of phenol formaldehyde resole; polyglycidyl ethers of novolak resins; resorcinol diglycidyl ether; glycidyl esters of aromatic carboxylic acids; and combinations thereof. The curable epoxy resin may further include other curable epoxy components, solvents, diluents, additives, and impurities.

The curable epoxy resin disclosed herein may be present in the curable part in an amount of, for example, 10-95% by weight, including 15-75% by weight, 20-55% by weight, and 20-35% by weight based on the total weight of the curable part. Based on the total weight of the multi-part composition, the weight percentage of the curable epoxy resin may be 2-60% by weight, including 5-40% by weight, 8-30% by weight, and 10-20% by weight.

The curable part also comprises a first silicate component. The first silicate component is one selected from an alumino silicate component and an alkali silicate or alkaline earth silicate component.

In accordance with the present disclosure, the alumino silicate component may comprise a calcined alumino silicate source such as metakaolin and fly ash and/or an amorphous alumino silicate source such as glass. When the first silicate component is an alumino silicate component, the alumino silicate component may be present in the curable part in an amount of, for example, 0.5-50% by weight, including 2-40% by weight, 3-30% by weight, and 4.5-20% by weight based on the total weight of the curable part. Based on the total weight of the multi-part composition, the weight percentage of the alumino silicate component may be 0.1-30% by weight, including 0.5-20% by weight, 0.8-15% by weight, and 1-10% by weight.

In accordance with the present disclosure, the alkali silicate or alkaline earth silicate component includes, but is not limited to, potassium silicate, sodium silicate, calcium silicate, and combinations thereof. When the first silicate component is an alkali silicate or alkaline earth silicate component, the alkali silicate or alkaline earth silicate component may be present in the curable part in an amount of, for example, 0.005-40% by weight, including 0.5-30% by weight, 1-35% by weight, and 2-20% by weight based on the weight of the curable part. Based on the total weight of the multi-part composition, the weight percentage of the alkali silicate or alkaline earth silicate component may be 0.001-30% by weight, including 0.1-20% by weight, 0.5-15% by weight, and 1-10% by weight.

The multi-part composition comprises a chemical blowing agent. In certain aspects of the present disclosure, the chemical blowing agent is present in the curable part. Accordingly, in certain aspects, the curable part comprises a chemical blowing agent. Suitable chemical blowing agents that may be used include, but are not limited to, a sulphonyl hydrazide selected from p-toluenesulfonylhydrazide, p,p′-oxybis(benzenesulfonyl-hydrazide), 2,4-toluenedisulfonylhydrazide, p-methylurethane ben-zene-sulfonylhydrazide, benzenesulfonylhydrazide, benzene-1,3-disulfonylhydrazide, diphen-ylsulfone-3,3′-disulfonylhydrazide, sulfone hydrazide, and combinations thereof.

In accordance with the present disclosure, the chemical blowing agent disclosed herein, when present in the curable part, is present in an amount of, for example, 0.01-50% by weight, including 2-30% by weight, 5-20% by weight, and 7-15% by weight based on the total weight of the curable part. Based on the total weight of the multi-part composition, the weight percentage of the chemical blowing agent may be 0.001-25% by weight, including 0.1-15% by weight, 1-10% by weight, and 2-5% by weight.

In some aspects of the present disclosure, the chemical blowing agent may be kept separate from the rest of the components of the curable part to improve shelf-stability and/or longevity of the multi-part composition. In such aspects, the blowing agent would be combined with the other components of the curable part (e.g., the epoxy resin and the first silicate component) prior to the combination with the curing part of the multi-part composition. In such aspects, the chemical blowing agent may be considered to constitute a separate, third part, i.e., the foaming part, of the multi-part composition. The chemical blowing agent disclosed herein may be present in the foaming part in an amount of, for example, 0.01-100% by weight, including 1-80% by weight, 10-60% by weight, and 20-40% by weight. The foaming part may comprise the chemical blowing agent together with water, solvents, other components (e.g., the alumino silicate component, the alkali silicate or alkaline earth silicate component), and additives, as disclosed herein.

### Curing Part

As discussed above, the multi-part composition comprises a curing part. The curing part comprises a curing agent. Suitable curing agents that may be used include, but are not limited to amido, amine, or amide curing agents, including aliphatic amido, amine or amide curing agents. The curing agents may be water-based. Examples of suitable amido, amine, or amide curing agents include, but are not limited to, Ancamide 903 MAV, the Jeffamine curing agents, TETA (triethylenetetramine)/TEPA (tetraethylenepentamine) and others known to those skilled in the art. An example of a suitable commercially available curing agent includes, but are not limited to, Anquamine 701, which is a water-based modified amine curing agent for epoxy resins.

In accordance with the present disclosure, the curing agent disclosed herein may be present in the curing part, in an amount of, for example, 10-95% by weight, including 20-75% by weight, 25-65% by weight, and 30-55% by weight based on the total weight of the curable part. Based on the total weight of the multi-part composition, the weight percentage of the curing agent may be 1-25% by weight, including 3-20% by weight, 5-15% by weight, and 7-10% by weight.

The curing part comprises a second silicate component. The second silicate component is one selected from the alumino silicate component and the alkali silicate or alkaline earth silicate component as described above, and is different from the first silicate component of the curable part. In some aspects of the present disclosure, the curable part comprises the alumino silicate component as the first silicate component, while the curing part comprises the alkali silicate or alkaline earth silicate component as the second silicate component. In other aspects of the present disclosure, the curable part comprises the alkali silicate or alkaline earth silicate component as the first silicate component, while the curing part comprises the alumino silicate component as the second silicate component.

When the second silicate component is the alumino silicate component, the alumino silicate component may be present in the curing part in an amount of, for example, 0.5-50% by weight, including 2-40% by weight, 3-30% by weight, and 4.5-20% by weight based on the total weight of the curing part. As described above, based on the total weight of the multi-part composition, the weight percentage of the alumino silicate component may be 0.1-30% by weight, including 0.5-20% by weight, 0.8-15% by weight, and 1-10% by weight. When the second silicate component is the alkali silicate or alkaline earth silicate component, the alkali silicate or alkaline earth silicate component may be present in the curing part in an amount of, for example, 0.005-40% by weight, including 0.5-30% by weight, 1-35% by weight, and 2-20% by weight based on the weight of the curing part. As described above, based on the total weight of the multi-part composition, the weight percentage of the alkali silicate or alkaline earth silicate component may be 0.001-30% by weight, including 0.1-20% by weight, 0.5-15% by weight, and 1-10% by weight.

### Additional Aspects

The multi-part composition comprises an activator that activates the chemical blowing agent, where the chemical blowing agent and the activator are separately present in different parts of the multi-part composition. In some aspects of the present disclosure, the curing agent may activate the chemical blowing agent. In such aspects, the curing agent would be an activator. Alternatively or in addition, the activator may comprise other components instead of the curing agent where the curing agent does not activate the chemical blowing agent, or in addition to the curing agent where the curing agent can activate the chemical blowing agent. In accordance with the present disclosure, the chemical blowing agent may be a sulphonyl hydrazide (e.g., p,p′-oxybis(benzenesulfonyl-hydrazide)) and the activator comprises one or more amido, amine, or amide functional compounds such as Anquamine 701, Anquamine 401, Ancamide 903, tetraethylenepentamine (TEPA), 4,7,10-trioxa-1,13-tridecanediamine, and Jeffamine curing agents. The activator lowers the decomposition temperature of the chemical blowing agent by catalysis or reaction. In some aspects of the present disclosure, the chemical blowing agent is p,p′-oxybis(benzenesulfonyl-hydrazide) and its decomposition temperature is lowered to ambient temperature by one or more of the activators described above.

When the multi-part composition comprises a third part (e.g., a foaming part), each of the first silicate component and the second silicate component may be present in the curable part, the curing part, and/or the third part, as long as the first silicate component and the second silicate component are not present in the same part. The third part may comprise one of the first silicate component and the second silicate component in an amount of, for example, 0.5-50% by weight, including 5-40% by weight, 10-30% by weight, and 15-20% by weight, or 50-100% by weight, including 60-95% by weight, 70-90% by weight, and 80-85% by weight based on the total weight of the third part. Furthermore, the multi-part composition can have more parts than the curable part, the curing part, and the foaming part. For example, the constituents of the multi-part composition can be broken down further into additional parts.

The multi-part composition comprises water. Based on the total weight of the multi-part composition, the weight percentage of water may be 0.1-80% by weight, including 0.1-70% by weight, 0.1-60% by weight, 0.1-50% by weight, 1-70% by weight, 3-60% by weight, 5-50% by weight, 10-45% by weight, 20-40% by weight, and 30-35% by weight. Water may be present in one or more of the curable part, the curing part, and additional parts of the multi-part composition in an amount of 0-80% by weight of each part, including 0.1-60% by weight, 0.5-40% by weight, and 1-25% by weight. The water in the multi-part composition may be introduced by the ingredients (e.g., water-based epoxy resin, water-based curing agent) or by addition of water into emulsifiable ingredients.

In accordance with the present disclosure, the multi-part composition may further comprise any ingredients suitable for forming a geopolymer as known in the geopolymer field, in addition to, or instead of the first silicate component and the second silicate component disclosed herein.

In accordance with the present disclosure, the multi-part composition may further comprise a base component. The base component may comprise alkali or alkaline earth hydroxide (e.g., sodium hydroxide, potassium hydroxide), carbonate (e.g., sodium carbonate), phosphate, or combinations thereof. In accordance with the present disclosure, the base component may assist the formation of geopolymer and/or affect the curing time by adjusting pH, for example, adjusting the pH of the reaction mixture to 8 to 13, including 8-12, and 9-11. Based on the total weight of the multi-part composition, the weight percentage of the base component may be 0-5% by weight, including 0.001-2% by weight, 0.01-1% by weight, and 0.05-0.1% by weight. The base component may be present in one or more of the curable part, the curing part, and additional parts of the multi-part composition in an amount of 0-20% by weight of each part, including 0.005-20% by weight, 0.01-10% by weight, 0.1-5% by weight, and 0.2-1% by weight based on the total weight of the respective part. For example, the base component may be present in the curable part, the curing part, or both, in such amounts.

In accordance with the present disclosure, the multi-part composition may further comprise additives comprising one or more of diluents, plasticizers, low-density fillers (e.g., ceramic spheres, glass bubbles), reinforcement fibers, heat absorbing fillers, microspheres, flame retardant pigments/liquids, intumescent components, and other pigments. Based on the total weight of the multi-part composition, the weight percentage of the additives may be 0-20% by weight, including 0.1-15% by weight, 0.2-10% by weight, and 0.5-5% by weight. The additives may be present in one or more of the curable part, the curing part, and additional parts of the multi-part composition in an amount of 0-30% by weight of each part, including 0.001-30% by weight, 0.01-25% by weight, 0.1-20% by weight, and 1-15% by weight.

To assist flame retardant properties of polymer foams, intumescent pigments such as ammonium polyphosphate may be added. However, such polymer foams may require the use of volatile solvents during their preparation so as to incorporate the ammonium polyphosphate and as a result have low strength with respect to density. In accordance with the present disclosure, forming the geopolymer within the epoxy polymer foam matrix has surprising effects on the preparation and properties of the foam. The hybrid foam may be formed at room temperature without the use of volatile solvents, have improved flame retardant property, have good mechanical strength with respect to density, and reduce shrinkage of the foam film, as compared to traditional foams having intumescent additives. Furthermore, in accordance with the present disclosure, the multi-part composition may have sustainable chemistry, being free of volatile solvents, isocyanates, and peroxides.

In accordance with the present disclosure, the geopolymer may also cure faster than the epoxy polymer foam matrix, which allows the application of an overcoat within a shorter period of time.

When used alone, geopolymers have spalling issues in building and construction applications. In accordance with the present disclosure, the epoxy polymer foam matrix helps the geopolymer in resisting spalling and improve the mechanical strength and stability.

### Method of Preparing

As discussed above, the method for preparing an epoxy-geopolymer hybrid foam comprises a step of mixing the multi-part composition disclosed herein. The multi-part composition may be a two-part composition consisting of the curable part and the curing part. The epoxy-geopolymer hybrid foam is formed by mixing the curable part and the curing part.

The multi-part composition may comprise one or more parts in addition to the curable part and the curing part. Generally, the epoxy-geopolymer hybrid foam is formed by mixing the curable part, the curing part, and any additional parts together. However, when the multi-part composition comprises the foaming part disclosed herein, the foaming part may be mixed with the curable part before mixing with the curing part. Including the chemical blowing agent in the foaming part and mixing with the curable part before preparing the epoxy-geopolymer hybrid foam may increase the shelf life, as compared to including the chemical blowing agent in the curable part.

When all of the parts of the multi-part composition are mixed and cured, the multi-part composition forms an epoxy-geopolymer hybrid foam. During the curing process, the mixing of the curable part and the curing part (and any additional parts) results in the formation of an epoxy polymer. The chemical blowing agent is activated by the curing agent and/or other activator in the reaction mixture to form a foam matrix. The first silicate component and the second silicate component (i.e., the alumino silicate component and the alkali silicate or alkaline earth silicate component) react with each other to form a geopolymer. As result, an epoxy-geopolymer hybrid foam is formed in which the geopolymer is dispersed within the epoxy polymer foam matrix.

In accordance with the present disclosure, the curing of the epoxy-geopolymer hybrid foam may result in a hydrophobic intermediate that expels water from the epoxy-geopolymer hybrid foam. Because this chemistry does not rely on natural aspiration to remove the water, the curing thickness and the fire application thickness of the epoxy-geopolymer hybrid foam are not limited by the need for natural aspiration. As such, the epoxy-geopolymer hybrid foam may by applied and cured into a foamed coating with higher thicknesses, as compared to waterborne foam products on the market which need exposure to air for removing water, e.g., greater than but not limited to 2 mm of thickness per coat, including greater than 5 mm, greater than 15 mm, and greater than 25 mm of thickness per coat.

In accordance with the present disclosure, the mixing and curing of the multi-part composition may have sustainable chemistry, producing no volatile organic compounds, isocyanates, peroxides, hydrogen, or low molecular weight hydrocarbons.

In accordance with aspects of the present disclosure, the multi-part composition is curable at a temperature in the range of 1° C. to 60° C. In accordance with other aspects, the multi-part composition is curable at a temperature greater than 60° C. In accordance with the present disclosure, the multi-part composition may be curable at around room temperature, e.g., about 15° C. to about 30° C. The multi-part composition may be heated to a desired temperature before or during mixing and curing.

The reaction mixture resulting in the foam may expand to 1.1 to 20 times the original volume during the step of mixing all parts of the multi-part composition, depending on the compositions and reaction conditions (e.g., viscosity of reaction mixture and reaction temperature), including 1.3 to 10 times, 1.4 to 5 times, and 1.5 to 3 times the original volume. In accordance with the present disclosure, the reaction mixture may expand to 1.5 to 3 times the original volume when the multi-part composition is mixed and cured at room temperature, e.g., about 15° C. to about 30° C.

The foaming during the step of mixing all parts of the multi-part composition may persist for 20 minutes to 5 hours depending on the compositions and reaction conditions (e.g., viscosity of reaction mixture and reaction temperature), including 0.5 to 4 hours, 1 to 3 hours, and 1.5 to 2 hours. In accordance with the present disclosure, the foaming may persist for approximately 1.5 hours when the multi-part composition is mixed and cured at room temperature, e.g., about 15° C. to about 30° C. Under similar conditions, the multi-part composition may be quicker to reach a final film thickness in comparison to syntactic foams. In accordance with the present disclosure, diluents and plasticizers may be added to the multi-part composition to lower the initial viscosity and extend the reaction time.

In accordance with the present disclosure, the epoxy-geopolymer hybrid foam may have a density of 0.05 to 4 g/cm³, including 0.1 to 2.5 g/cm³, 0.125 to 1 g/cm³, and 0.15 to 0.75 g/cm³.

In accordance with the present disclosure, the epoxy-geopolymer hybrid foam may have an average cell size in the range of 20 to 6000 μm, including 30 to 3000 μm, 40 to 1000 μm, and 50 to 100 μm, as determined by, for example, an optical digital microscope (e.g., Keyence VHX5000) with measuring capability, calibrated to a reference standard, and measuring the diameter of each cell and taking an average. The cell size depends on the compositions and reaction conditions, e.g., viscosity of reaction mixture, reaction temperature, and the blowing agent and its concentration. In accordance with the present disclosure, the epoxy-geopolymer hybrid foam may achieve an average cell size within the range of 40 to 100 μm when the curing occurs at around room temperature, e.g., about 15° C. to about 30° C.

In accordance with the present disclosure, the epoxy-geopolymer hybrid foam may achieve a uniform cell size (e.g., coefficient of variation of less than 0.2) and no discernable variation in cell size in the top vs. bottom of the specimen.

In accordance with the present disclosure, the epoxy-geopolymer hybrid foam may have a compressive strength of 100-10,000 psi, including 1,500-9,000 psi, 3,000-8,000 psi, and 5,000-7,000 psi. Compressive strength can be measured by, for example, the compression testing procedures according to ASTM D1621.

In accordance with the present disclosure, the epoxy-geopolymer hybrid foam may have an adhesive strength of 150-10,000 psi against a surface of steel, wood, or masonry, including 300-8,000 psi, 400-6,000 psi, and 500-4,000 psi when divided by cured density (in g/cm³). Adhesive strength can be measured by ASTM D4541.

In accordance with the present disclosure, the epoxy-geopolymer hybrid foam may present more compressive and adhesive strength than traditional insulative foams. When density is factored in, the epoxy-geopolymer hybrid foam may provide 72 psi to 11,000 psi of compressive strength. The epoxy-geopolymer hybrid foam may provide better adhesive strength as compared to foams currently on the market (e.g., Great Stuff and DAP brands) which have approximately 800-1,110 psi of adhesive values.

In accordance with the present disclosure, the epoxy-geopolymer hybrid foam may present thermal insulating properties. Under ASTM C518 standard, the epoxy-geopolymer hybrid foam may have K values as low as 0.041. Accordingly, the K values may range from about 0.04 to less than 1.

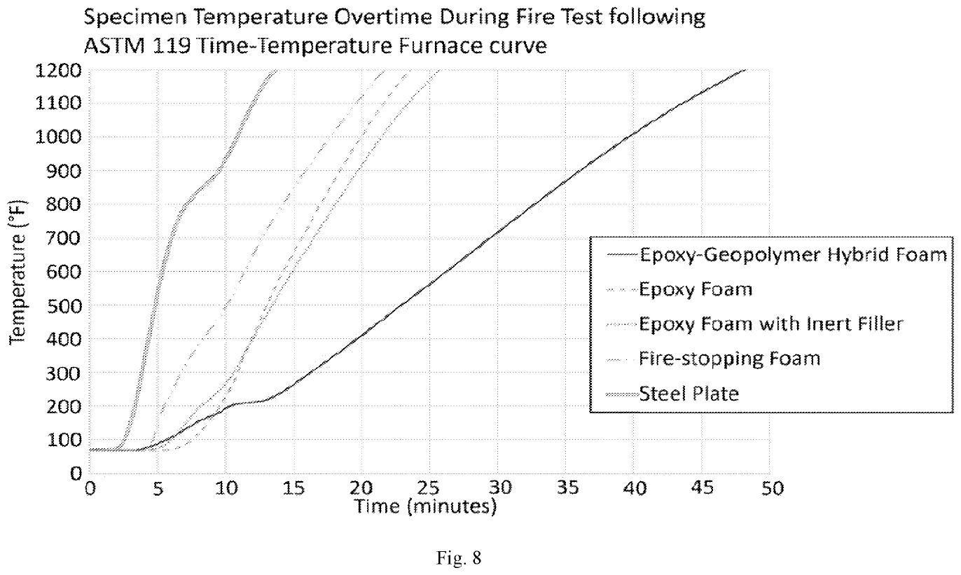

In accordance with the present disclosure, the epoxy-geopolymer hybrid foam may present flame retardant properties. As shown in FIG. 8, when steel plates specimens coated with the foams of the present disclosure are fire tested according to ASTM E119 and E84, the specimen coated with the epoxy-geopolymer hybrid foam may have temperature rising at a slower rate compared to specimen coated with the neat foam (“Epoxy Foam,” which is the same as the epoxy-geopolymer hybrid foam except that it is formed without the geopolymer), the neat foam with an inert filler, or other fire-stopping foam products on the market. Accordingly, the epoxy-geopolymer hybrid foam may have superior flame-retardant properties, such as longer time until maximum temperature of a protected substrate is reached, when compared to insulative foams presently on the market. In addition, when compared to the epoxy foam without the geopolymer, the epoxy-geopolymer hybrid foam is again superior in flame retardancy. The epoxy-geopolymer hybrid foam may also have improved anti-flammability (in terms of spread of flame values) under ASTM E84 test standard over existing foam products.

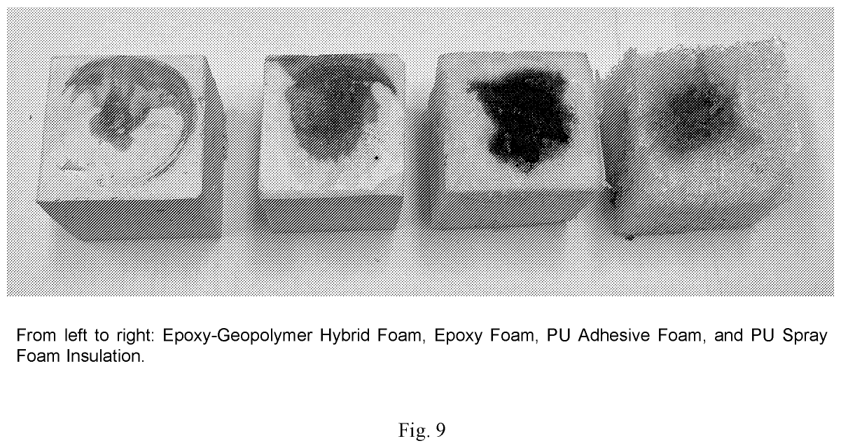

In accordance with the present disclosure, the epoxy-geopolymer hybrid foam may present chemical resistant properties. For example, as shown in FIG. 9, upon direct exposure of concentrated sulfuric acid, only minor discoloration on the surface of the epoxy-geopolymer hybrid foam was observed. On the other hand, each of the neat foam (“Epoxy Foam,” which is the same as the epoxy-geopolymer hybrid foam except that it is formed without the geopolymer), PU adhesive foam (Great Stuff brand), and PU spray foam insulation (Great Stuff brand) had surface/interior degradation. The epoxy-geopolymer hybrid foam may present unexpectedly improved acid resistance over a mixture of separately produced epoxy foam and geopolymer.

In accordance with the present disclosure, the epoxy-geopolymer hybrid foam may present cryogenic properties, e.g., stability and strength at low temperatures. For example, the epoxy-geopolymer hybrid foam may be tested according to the method of the ISO20088-1 standard, where the hybrid foam is exposed to liquid nitrogen and cooled. In accordance with the present disclosure, the hybrid foam may not crack or delaminate from the substrate when cooled down to 0° C., −20° C., −50° C., or even −196° C., despite the substrate reaching sub-ambient temperatures over time.

After curing, the epoxy-geopolymer hybrid foam may be formed by spraying onto a substrate or extruding, in accordance with methods known in the art. Alternatively, the multi-part composition may be mixed and applied (e.g., brushing, rolling, pouring, dip coating) to a substrate during the curing process, such that the curing occurs on the substrate and the epoxy-geopolymer hybrid foam adapts to the shape of the substrate. Different parts of the multi-part composition may also be separately applied to a substrate, and then mixed and cured.

In accordance with the present disclosure, the epoxy-geopolymer hybrid foam may be suitable as a cavity filler, penetration seal, or impact mitigation material for construction or damage repairs. The epoxy-geopolymer hybrid foam may be lightweight and provide good inherent strength with respect to its density. The epoxy-geopolymer hybrid foam may provide flame retardant properties such that there is no need to use an additional flame retardant coating. The epoxy-geopolymer hybrid foam may also be used as a protective material, for example, as a coating for cryogenic spill damage mitigation or personnel protection from hot or cold substrates. The epoxy-geopolymer hybrid foam may act as an alternative to polyisocyanurate (PIR) or polyurethane (PU) foams in building and construction applications due to good strength and more sustainable chemistry.

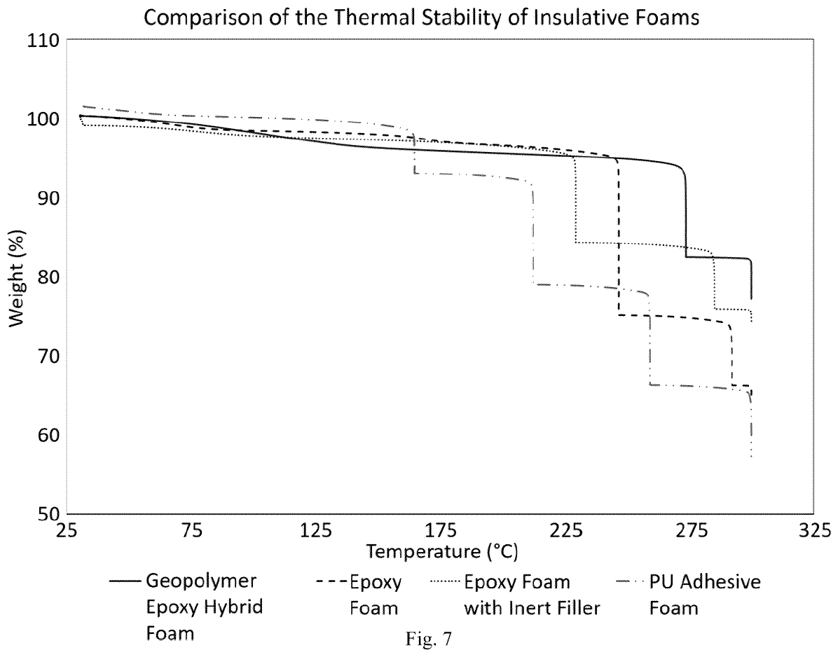

In accordance with the present disclosure, the epoxy-geopolymer hybrid foam may have thermal stability for temperatures up to 225° C., up to 260° C., up to 300° C., or even up to 400° C. As shown in FIG. 7, the epoxy-geopolymer hybrid foam of the present disclosure may have a higher decomposition temperature compared to specimens of the neat foam (“Epoxy Foam,” which is the same as the epoxy-geopolymer hybrid foam except that it is formed without the geopolymer), the neat foam with an inert filler, or other low density foam products (e.g., PU adhesive foam from Great Stuff brand).

### Examples

### 1. Exemplary Formulation

The following multi-part composition was prepared in accordance with the disclosure above:

| | | | Based on total |
|---|---|---|---|
| | | | weight of |
| | | | each Part |
| Curable | Curable epoxy | Polyglycidyl ethers of | 35% |
| Part | resin | bisphenol A | |
| | First silicate | Metakaolin | 50% |
| | component | | |
| | Chemical | p,p′-oxybis(benzenesulfonyl- | 15% |
| | blowing agent | hydrazide) | |
| Curing | Curing agent | Anquamine 701 | 55% |
| Part | Second silicate | Sodium silicate | 20% |
| | component | | |
| | Water | | 24% |
| | Base | Sodium Hydroxide | 1% |

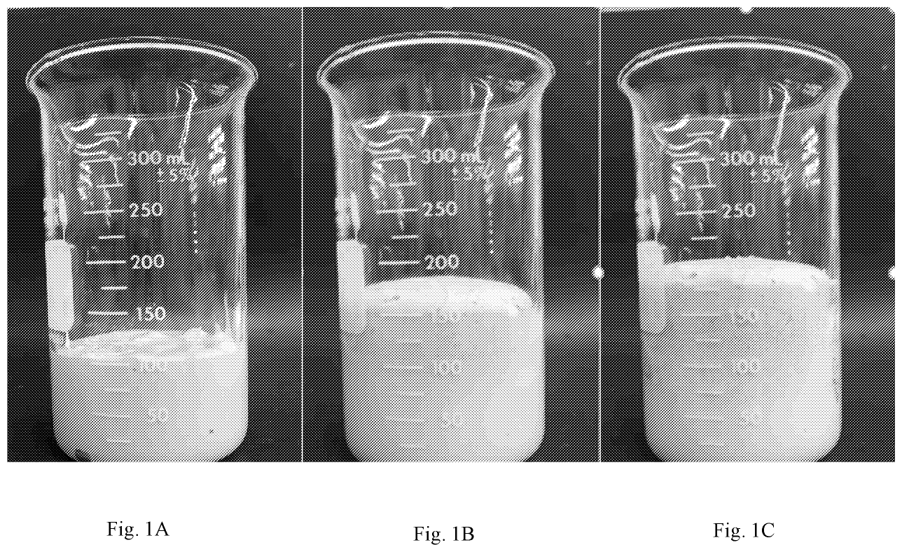

The multi-part composition was mixed and cured at about 25° C. As shown in FIGS. 1A-1C, the reaction mixture expanded to about 1.5 times the original volume at about 1 hour after mixing, and reached the maximum volume of about 1.75 times the original volume at about 1 hour and 25 minutes after mixing. The foaming persisted for approximately 1.5 hours.

50 mm thick×300 mm diameter cylindrical samples were produced of the epoxy-geopolymer hybrid foam, where foam cell structure was confirmed to be uniform with a cell size distribution between 70-180 μm (with an average cell size of 115 μm). There was no discernable variation of cell size in the top of the specimen vs. bottom.

2. Comparison with Existing Products

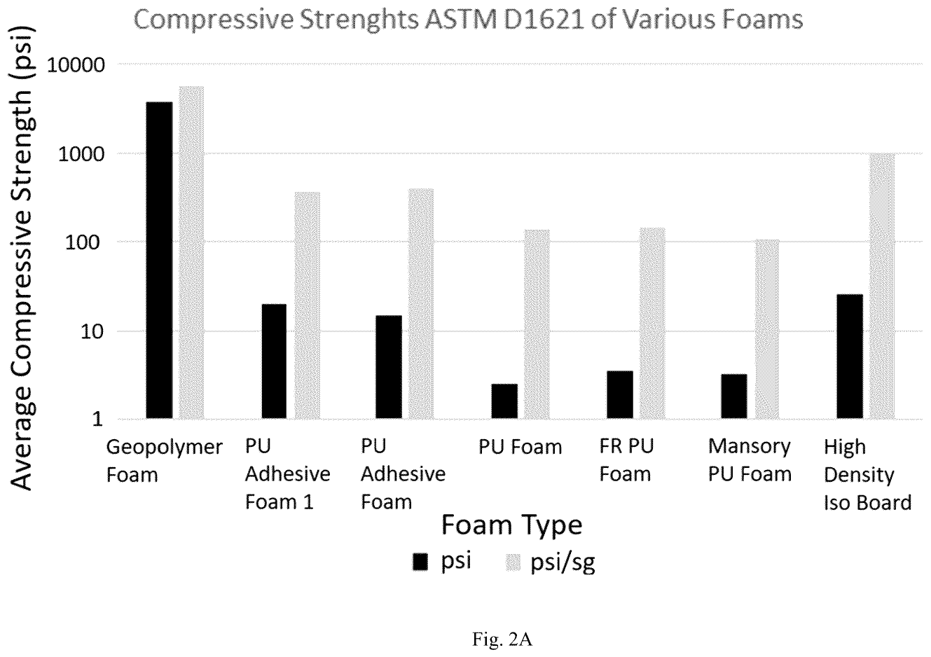

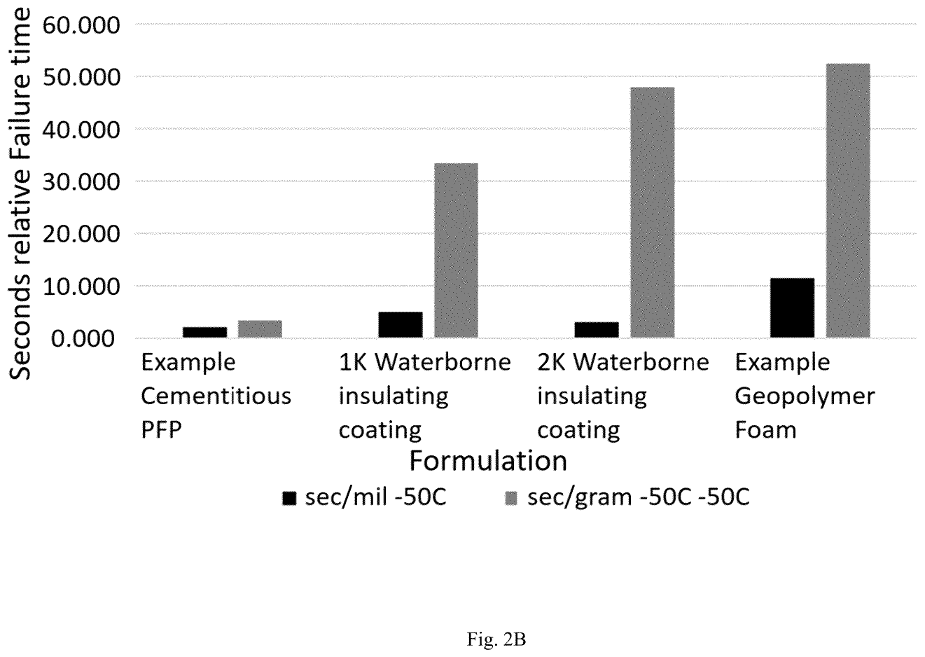

Epoxy-geopolymer hybrid foam was prepared in accordance with the present disclosure, and tested together with existing insulative foam products. Compressive strength was tested according to ASTM D1621. Adhesive strength up to 2,000 psi with a steel substrate was tested according ASTM 4541. As shown in FIG. 2A, the epoxy-geopolymer hybrid foam (“Geopolymer Foam”) has improved compressive strength over the existing products, expressed as a function of density.

In addition, the epoxy-geopolymer hybrid foam was subjected to cryogenic exposure testing, together with comparative foams (epoxy foam and intumescent additive in 2:1 ratio, a 2k water-based insulation product, and 1k water-based product used for insulation). The specimens (a coating applied to a steel substrate) were exposed to liquid nitrogen and the time (in seconds) until a temperature of −50° C. was measured at the back of the substrate. As shown in FIG. 2B, the epoxy-geopolymer hybrid foam (“Example Geopolymer Foam”) has improved cryogenic exposure resistance over the comparative foams and the existing products, in terms of both minutes to failure temperature per thickness and minutes to failure temperature per cured & applied weight. The ISO20088-1,2,3 standards for resistance to cryogenic spillage operate on different testing setups with specimens of a larger scale, but since the testing conditions are analogous, it is expected that the epoxy-geopolymer hybrid foam also has improved cryogenic exposure resistance under the ISO20088-1,2,3 standards.

### 3. NMR Characterization of Geopolyerization Products

During geopolyerization the coordination of aluminum and silicon atoms and bond lengths are affected. The changes in the chemical environment around the aluminum and silicon atoms can be studied with 27Al and 29Si solid-state NMR. Samples of unreacted geopolymer ingredients (grey, the alumino silicate component and the alkali silicate or alkaline earth silicate component), cured geopolymer (purple), cured geopolymer pulverized than mixed with an epoxy foam (green), and epoxy-geopolymer hybrid foam (red) prepared in accordance with the present disclosure were tested.

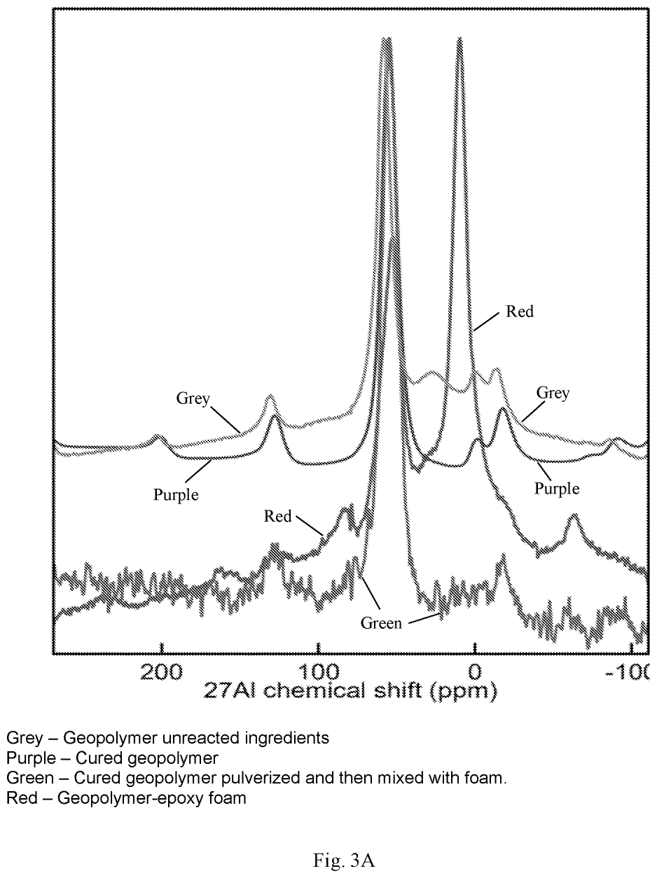

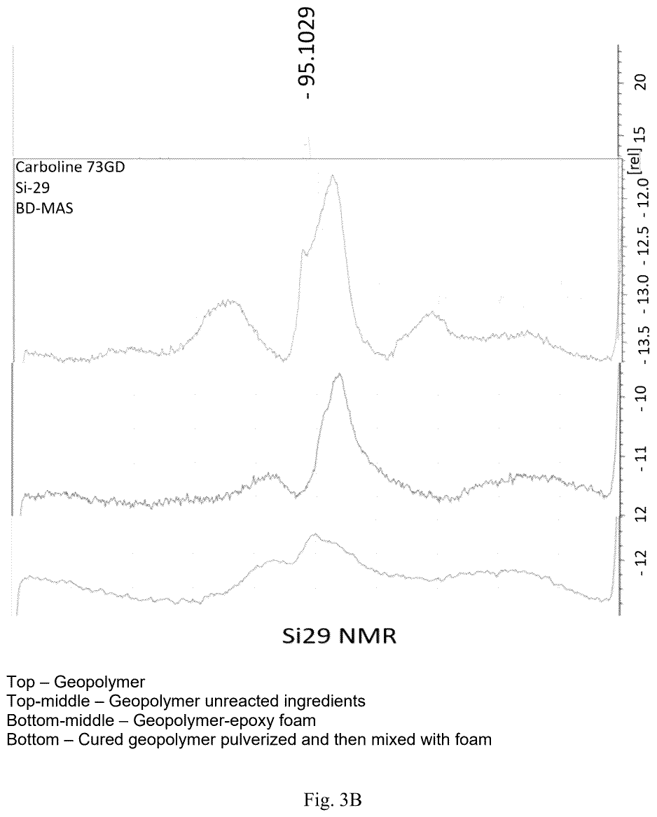

As shown in FIGS. 3A and 3B, samples with cured geopolymer have chemical shifts and peak heights different from the spectrum of the unreacted ingredients, signifying changes to the chemical environment that occur during geopolymerization. Notably, in both ²⁷Al and ²⁹Si NMR spectrum, the epoxy-geopolymer hybrid foam shows additional peak (e.g., around 0 ppm in ²⁷Al) or shifted peaks as compared to the sample prepared by mixing pulverized geopolymer with an epoxy foam. This implicates that by the multi-part composition of the present disclosure, the geopolymer is integrated differently (i.e., dispersed) into the epoxy polymer foam matrix which results in unique mechanical and thermal properties of the hybrid foam.

### 4. Infrared Spectroscopy Characterization of Geopolyerization Products

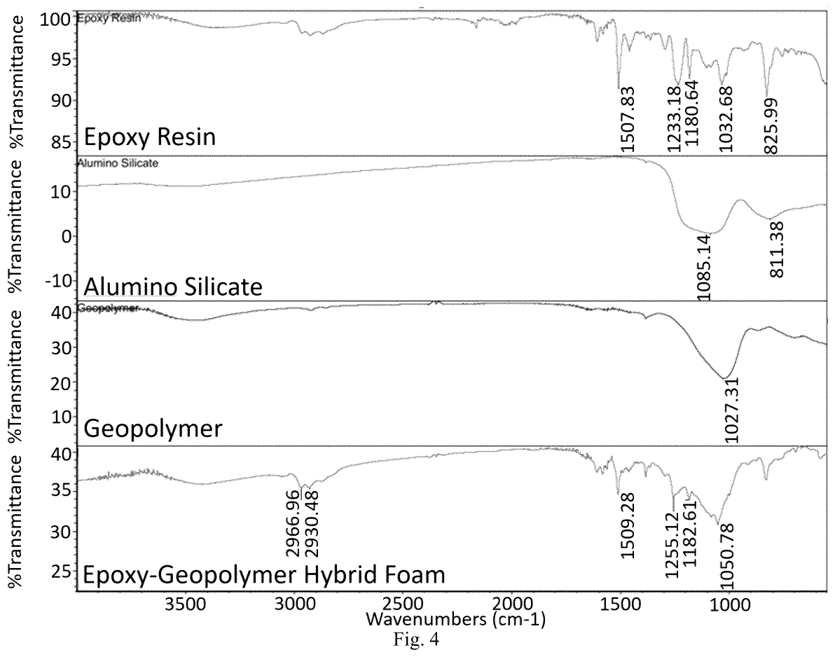

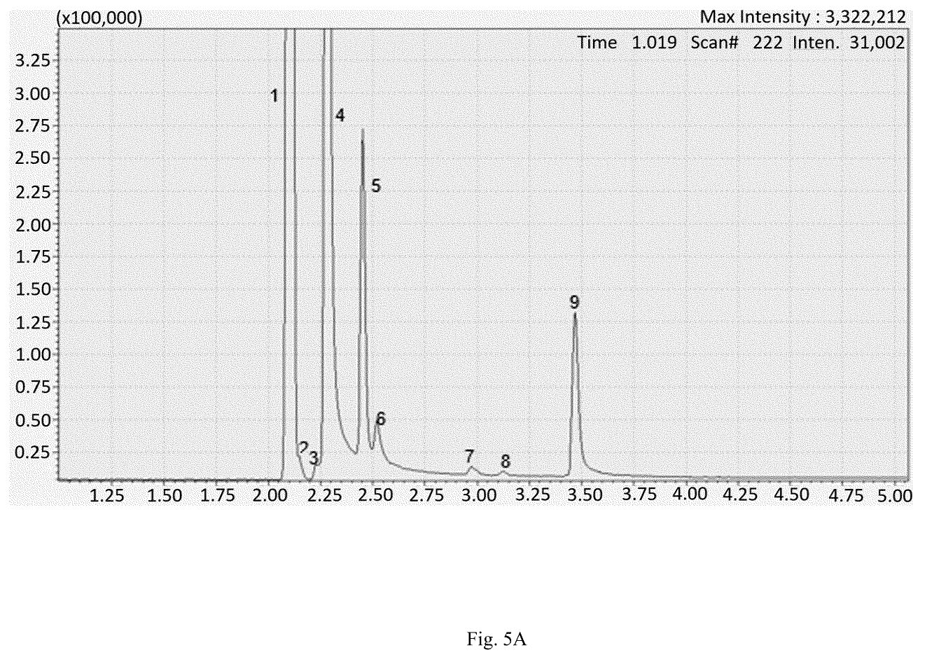

To further analyze the changes in the coordination and bonding of the atoms during geopolyerization, infrared spectroscopy was conducted on the epoxy-geopolymer hybrid foam (bottom of FIG. 4) and compared with that of cured epoxy resin (top of FIG. 4), the alumino silicate ingredient of the geopolymer (second from top of FIG. 4), and the cured geopolymer (second from bottom of FIG. 4). As shown in FIG. 4, the peak at 1085 cm⁻¹ in the alumino silicate spectrum narrows and shifts to 1027 cm⁻¹ and 1050 cm⁻¹ in the cured geopolymer and the epoxy-geopolymer hybrid foam spectrums, respectively. The shift cannot be attributed to the presence of epoxy resin, and therefore is likely due to a change in the microstructural formation. This indicates that a similar if not the same geopolyerization reaction takes place in the epoxy-geopolymer hybrid foam as does in the standard geopolymer formation.

### 5. Evolved Gas Analysis

GC-MS was used to analyze the gas produced in the foaming process according to the present disclosure. 8 g an amine activator was mixed with 2 g of p,p′-oxybis(benzenesulfonyl-hydrazide), and mixed well. About 0.7 g of this reaction mixture was put into a 20 mL headspace vial, sealed, and the purged with helium. This was accomplished by using a helium line with a needle on the end to supply helium through the septum of the vial and a second syringe needle to act as an exit for the gas. After purging with helium, the headspace vial was heated for 10 minutes at 45° C. and the gas analyzed using GC-MS.

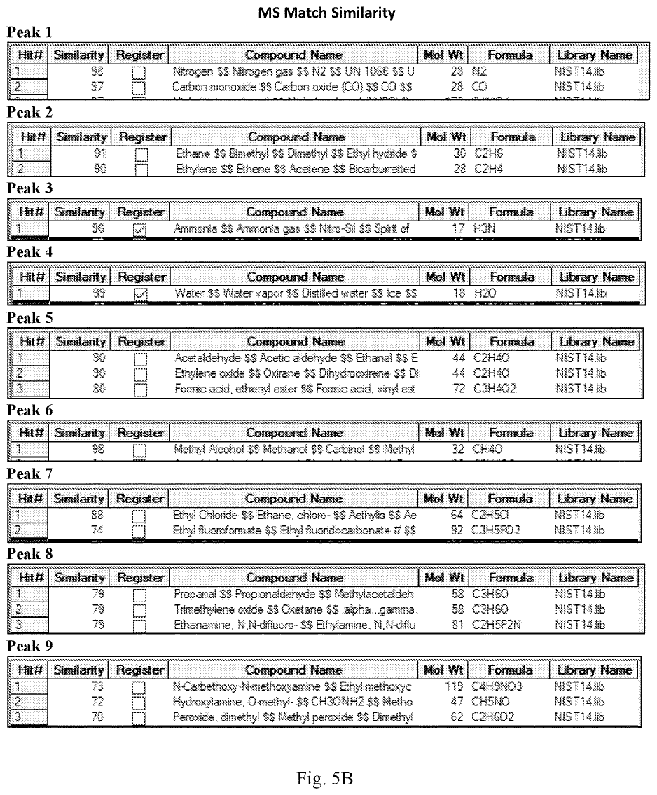

As shown in FIGS. 5A and 5B, the largest peaks by area and height in the GC-MS chromatogram correspond to nitrogen and water, indicating that the foaming process is consistent with the chemical blowing mechanism of sulphonyl hydrazide as understood in the art.

### 6. Rate of N₂ Production

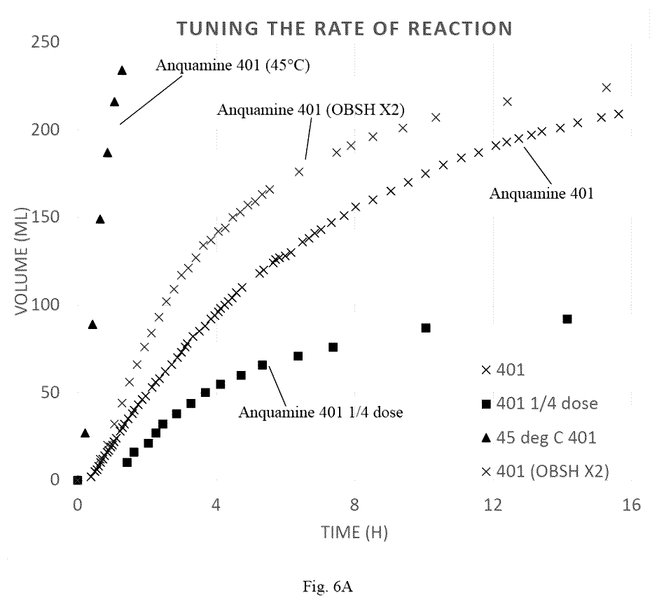

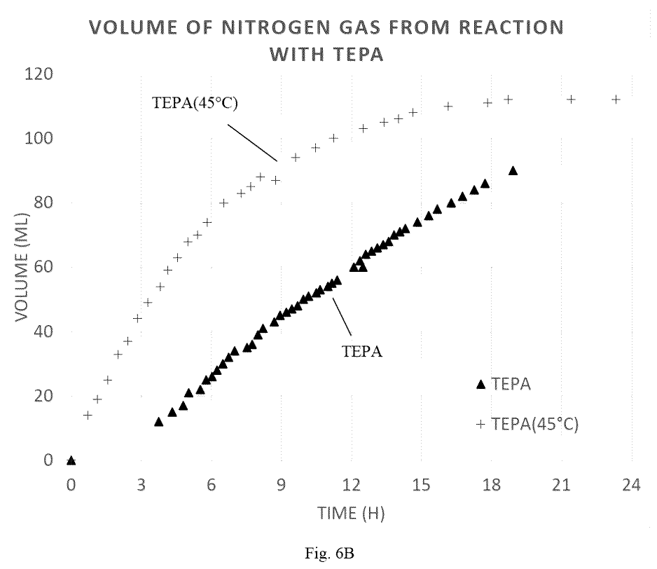

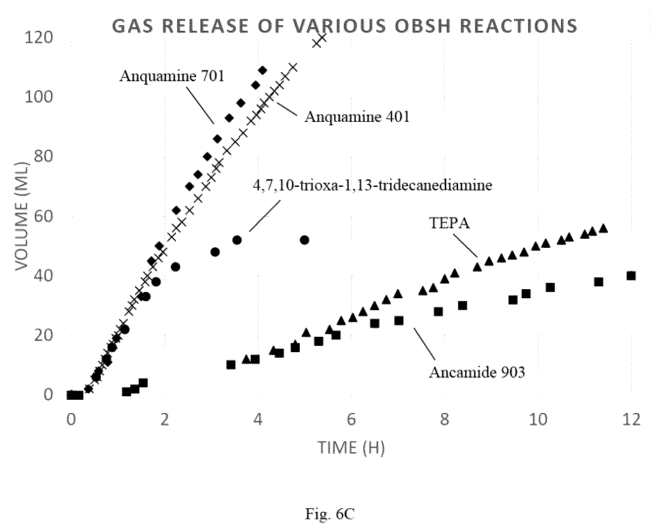

To study the rate of activation of the chemical blowing agent, the rate of N₂ gas production was monitored under a variety of conditions. A round bottom flask containing 47.5 g of Anquamine 401, 30 g of water, and 2.5 g of p,p′-oxybis(benzenesulfonyl-hydrazide) was continuously mixed using a stir bar. The volume of released N₂ gas was measured over time. The reaction is repeated and monitored with various temperature and ratio of Anquamine 401 and p,p′-oxybis(benzenesulfonyl-hydrazide), as plotted in FIG. 6A. It is shown that the rate of N₂ release can be controlled by adjusting the temperature and the ratio of components. The rate of N₂ release at 45° C. was 16 time that at ambient.

Tests were conducted with the reactions of p,p′-oxybis(benzenesulfonyl-hydrazide) with other chemicals including Anquamine 701, tetraethylenepentamine (TEPA), Ancamide 903, Anquamine 401, 4,7,10-trioxa-1,13-tridecanediamine, and Jeffamine curing agents. FIG. 6B shows the results from the reaction with TEPA, which again demonstrates the effect of temperature on the rate of N₂ release. FIG. 6C shows a comparison of the ability of promoting N₂ release of all the tested chemicals.

While the present disclosure describes exemplary aspects of compositions and methods in detail, the present disclosure is not intended to be limited to the disclosed aspects. Also, certain elements of exemplary aspects disclosed herein are not limited to any exemplary aspects, but instead apply to all aspects of the present disclosure.

The terminology as set forth herein is for description of the aspects of this disclosure only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Furthermore, the phrase “at least one of A, B, and C” should be interpreted as “only A or only B or only C or any combinations thereof.”

The multi-part composition and the associated method of the present disclosure can comprise, consist of, or consist essentially of the essential elements of the disclosure as described herein, as well as any additional or optional element described herein or which is otherwise useful in preparing and applying epoxy-geopolymer hybrid foams.

All percentages, parts, and ratios as used herein are by weight of the total composition, unless otherwise specified. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

1. A multi-part composition comprising:
a curable part, comprising:
a curable epoxy resin, and
a first silicate component; and
a curing part, comprising:
a curing agent, and
a second silicate component;
wherein the multi-part composition comprises a chemical blowing agent,
wherein the first silicate component and second silicate component are different,
wherein the multi-part composition comprises water in an amount of 0.1 to 80 weight % based on the total weight of the multi-part composition,
wherein when mixed and cured, the multi-part composition forms an epoxy-geopolymer hybrid foam.

2. The multi-part composition of claim 1, wherein the first silicate component and the second silicate component are respectively selected from (a) an alumino silicate component and (b) an alkali silicate or alkaline earth silicate component.

3. The multi-part composition of claim 1, wherein the chemical blowing agent is present in the curable part.

4. The multi-part composition of claim 1, wherein the multi-part composition further comprises a foaming part, wherein the chemical blowing agent is present in the foaming part.

5. The multi-part composition of claim 3, wherein the curable part comprises, based on the total weight of the curable part:
10 to 95 weight % of the curable epoxy resin,
0.5 to 50 weight % of the alumino silicate component, and
0.01 to 50 weight % of the chemical blowing agent.

6. The multi-part composition of claim 1, wherein the curable epoxy resin is selected from polyglycidyl ethers of bisphenol A, polyglycidyl ethers of bisphenol F, polyglycidyl amines, polyglycidyl ethers of phenol formaldehyde resole, poly-glycidyl ethers of novolak resins, resorcinol diglycidyl ether, glycidyl esters of aromatic car-boxylic acids, and combinations thereof.

7. The multi-part composition of claim 2, wherein the alumino silicate component comprises metakaolin, fly ash, glass, and combinations thereof.

8. The multi-part composition of claim 1, wherein the chemical blowing agent is a sulphonyl hydrazide selected from p-toluenesulfonylhydrazide, p,p′-oxybis(benzenesulfonyl-hydrazide), 2,4-toluenedisulfonylhydrazide, p-methylurethane ben-zene-sulfonylhydrazide, benzenesulfonylhydrazide, benzene-1,3-disulfonylhydrazide, diphen-ylsulfone-3,3′-disulfonylhydrazide, sulfone hydrazide, and combinations thereof.

9. The multi-part composition of claim 1, wherein the curing part comprises, based on the total weight of the curing part:
10 to 95 weight % of the curing agent, and
0.005 to 40 weight % of the alkali silicate or alkaline earth silicate component.

10. The multi-part composition of claim 1, wherein the curing agent is a water-based amido, amine, or amide curing agent.

11. The multi-part composition of claim 2, wherein the alkali silicate or alkaline earth silicate component comprises potassium silicate, sodium silicate, and combinations thereof.

12. The multi-part composition of claim 1, wherein the curing part further comprises a base component, wherein the base component comprises alkali or alkaline earth hydroxide, carbonate, phosphate, or combinations thereof.

13. (canceled)

14. The multi-part composition of claim 1, wherein the multi-part composition is free of volatile solvents, isocyanates, and peroxides.

15. The multi-part composition of claim 1, wherein the epoxy-geopolymer hybrid foam has a compressive strength of 100 to 10,000 psi.

16. The multi-part composition of claim 1, wherein the epoxy-geopolymer hybrid foam has an adhesive strength of 500 to 4,000 psi, as divided by cured density, according to ASTM D4541 when applied to steel, wood, or masonry.

17. The multi-part composition of claim 1, wherein the epoxy-geopolymer hybrid foam has a density of 0.05 to 4 g/cm³.

18-21. (canceled)

22. A method for preparing an epoxy-geopolymer hybrid foam comprising one of A and B:
wherein A comprises:
mixing a multi-part composition comprising a curable part and a curing part,
wherein the curable part comprises:
a curable epoxy resin;
a first silicate component; and
a chemical blowing agent,
wherein the curing part comprises:
a curing agent; and
a second silicate component,
wherein the first silicate component and second silicate component are different, and wherein B comprises:
mixing a curable part and a foaming part to form a mixture, and
mixing a curing part into the mixture,
wherein the curable part comprises
a curable epoxy resin; and
a first silicate component,
wherein the curing part comprises:
a curing agent; and
a second silicate component,
wherein the foaming part comprises:
a chemical blowing agent,
wherein the first silicate component and second silicate component are different.

23. (canceled)

24. The method for preparing an epoxy-geopolymer hybrid foam of claim 22, wherein the first silicate component and the second silicate component are respectively selected from (a) an alumino silicate component and (b) an alkali silicate or alkaline earth silicate component.

25. The method for preparing an epoxy-geopolymer hybrid foam of claim 22, wherein the epoxy-geopolymer hybrid foam is cured in a temperature in the range of 1° C. to 60° C.

26. The method for preparing an epoxy-geopolymer hybrid foam of claim 22, wherein the epoxy-geopolymer hybrid foam is cured at a temperature greater than 60° C.

27-32. (canceled)
